(19) United States
(12) Patent Application Publication
(10) Pub. No.: US 2015/0332008 A1
(43) Pub. Date: Nov. 19, 2015

(54) Method and System for Providing a Telecare Service

(71) Applicant: TELECOM ITALIA S.P.A., Milano (IT)

(72) Inventors: Fabio Bellifemine, Torino (IT); Gabriele Elia, Torino (IT); Roberta Giannantonio, Torino (IT); Alessia Salmeri, Torino (IT)

(73) Assignee: TELECOM ITALIA S.P.A., Milano (IT)

(21) Appl. No.: 14/651,416

(22) PCT Filed: Dec. 21, 2012
(86) PCT No.: PCT/EP2012/076738

§ 371 Date: Jun. 11, 2015

(51) Int. Cl. G06F 19/00

(52) U.S. Cl. CPC G06F 19/3418

(57) ABSTRACT

A method is disclosed for providing a telecare service to a patient. According to the method, at least one sensor installed in a domestic environment of the patient detects a datum relating to either the domestic environment or an interaction between patient and domestic environment. Based on the detected datum, an anomaly in the domestic environment or in the interaction between patient and domestic environment is detected. Then, a predefined question uniquely associated with the detected anomaly is selected for generating a questionnaire to be submitted to the patient, with the purpose of determining the cause of the detected anomaly. Based on the patient's reply it is determined if the detected anomaly is a false anomaly and, in the affirmative, the predefined question associated to such false anomaly is excluded from the next questionnaire(s), even if the anomaly persists.

### TECHNICAL FIELD

The present invention relates to the field of telecare services. In particular, the present invention relates to a method and system for providing a telecare service.

### BACKGROUND ART

As known, a telecare service is a service providing remote monitoring and assistance to elderly people and/or people affected by a chronic disease or a physical disability who live alone.

Implementing a telecare service typically requires installing a suitable device at the patients premises, which may generate alarms informing either a call centre or the patient's relatives that the patient urgently needs help.

Known telecare services may also provide for periodic calls to the patient by an operator of a call centre. During the call, the operator typically asks a number of questions to the patient, which relate to her/his daily activities, for the purpose of checking her/his overall state of health. The questionnaire typically comprises several predefined questions relating to various aspects of the patient's everyday routine (sleep, diet, physical activity, etc.). Posing all the questions to the patient may then take a quite long time to the operator. Furthermore, some of the questions may be superfluous, since they might relate to aspects of the patients routine that are not critical in view of her/his specific disease or disability.

US 2004/0059196 describes a patient monitoring system for the automatic registration of the restrictions of a patient on daily abilities. The system comprises an electronic expert system which automatically presents the patient with questions which take into account his personal conditions and/or his medical history and documents and evaluates the replies and, from this, if necessary derives new specific questions to the patient. For this purpose, the electronic expert system has access to a central or decentral electronic patient record and also to the sensor data from a patient monitoring system.

### SUMMARY OF THE INVENTION

The Applicant has perceived that the above patient monitoring system has some drawbacks.

Indeed, according to the above patient monitoring system, the selection of personalized questions is based upon:
(i) information which shall be manually updated e.g. by a physician (namely, the central or decentral electronic patient record);
(ii) information provided by the patient's her/himself (namely, the patient's replies to the previous questions), which are not objective and are intrinsically unreliable because the patient often does not exactly remember in detail her/his daily activities of the past few days or because the patient sometimes may deliberately lie; and
(iii) sensor data from the patient monitoring system. Also such sensor data may be however unreliable, because the patient may not wear the sensor(s) in the proper way or she/he may even deliberately or accidentally omit to wear the sensor(s).

Therefore, the questions selected based upon the above information might be not well focused on the patient's actual current situation, since such information may be not updated and/or not reliable. Hence, the selected questions may fail to investigate the aspects of the patient's routine that are most critical in view of her/his actual current state of health.

In view of the above, the Applicant has tackled the problem of providing a method and system for providing a telecare service to a patient, which overcomes the aforesaid drawbacks.

In particular, the Applicant has tackled the problem of providing a method and system for providing a telecare service to a patient, wherein questions to be posed to the patient are selected based on automatically updated, objective and reliable information, so that the selected questions are well focused on the actual current situation of the patient and allow the operator to promptly check by means of a very short questionnaire the aspects of patient's everyday routine which appear to be most critical.

In the present description and in the claims, the term “anomaly” will indicate a discrepancy between:
normal domestic environment conditions or normal daily interactions between patient and domestic environment; and
actual domestic environment conditions or actual interaction between patient and domestic environment as detected by one or more sensors installed at the patient's premises.

An anomaly may be for instance a door left open for a too long time, an appliance left unused for a too long time, a too low room temperature, etc.

According to a first aspect, the present invention provides a method for providing a telecare service to a patient, the method comprising:
a) by means of at least one sensor installed in a domestic environment of the patient, detecting a datum relating to the domestic environment or an interaction between the patient and the domestic environment;
b) detecting an anomaly in the domestic environment or in the interaction between the patient and the domestic environment based on the detected datum; and
c) selecting at least one predefined question uniquely associated with the detected anomaly for generating a questionnaire to be submitted to the patient for determining a cause of the detected anomaly.

Preferably, step b) comprises checking whether the detected datum fulfils a predefined condition associated to the predefined anomaly.

According to first embodiments, step b) comprises checking whether a value of the detected datum is lower than, higher than or equal to a predefined value Vth.

According to second embodiments, step b) comprises checking whether a value of the detected datum is equal to a predefined value Vth for a time longer than, shorter than or equal to a predefined duration ΔTth.

Preferably, step b) is periodically performed with a predefined anomaly detection period.

According to the second embodiments, the predefined anomaly detection period is shorter than the predefined duration ΔTth.

Preferably, step c) comprises retrieving the at least one predefined question from a database storing an association between the anomaly and the at least one predefined question.

Preferably, the method further comprises:
d) submitting the at least one predefined question (QST(n)) to the patient (P); and
e) collecting from the patient (P) at least one reply to the at least one predefined question (QST(n)).

According to preferred variants, steps d) and e) are automatically performed via web.

Preferably, the method further comprises:
f) based on the at least one reply, determining whether the detected anomaly is a false anomaly or a true anomaly.

Preferably, the method further comprises excluding the at least one predefined question from a next questionnaire to be submitted to the patient, in case at step f) it was determined that the detected anomaly is a false anomaly. This advantageously allows avoiding needlessly submitting again the question to the patient, since it has already been ascertained that the detected anomaly is a false anomaly (namely, it was not due to health reasons which require an intervention or a further investigation at the patient's premises).

Optionally, step f) further comprises, if the detected anomaly is a false anomaly, associating an expiration time to the false anomaly. A false anomaly may indeed be due either to a sporadic event in the patient's routine or in a lasting change of her/his routine. The expiration time is then shorter in the first case, while it might be longer in the second case.

Preferably, the method further comprises selecting again the at least one predefined question for generating a further questionnaire to be submitted to the patient, if the expiration time is expired.

According to a second aspect, the present invention provides a telecare system for providing a telecare service to a patient, the telecare system comprising:
a) at least one sensor installed in a domestic environment of the patient, the at least one sensor being suitable for detecting a datum relating to the domestic environment or an interaction between the patient and the domestic environment;
b) an anomaly detection module configured to detect an anomaly in the domestic environment or in the interaction between the patient and the domestic environment based on the detected datum; and
c) a questionnaire generation module configured to select at least one predefined question uniquely associated with the detected anomaly for generating a questionnaire to be submitted to the patient for determining a cause of the detected anomaly.

Preferably, the telecare system further comprises a database storing an association between the anomaly and the at least one predefined question.

Preferably, the telecare system further comprises a communication network supporting communication between the at least one sensor, the anomaly detection module and the questionnaire generation module.

According to preferred embodiments, the anomaly detection module and the questionnaire generation module are executed in a distributed way within the communication network according to a cloud computing technique.

Preferably, the telecare system further comprises a gateway installed in said domestic environment and configured to gather data detected from said at least one sensor.

Preferably, the gateway is configured to process said data, in particular to enter said data in a detected data table and make said detected data table available to at least said anomaly detection module.

Preferably, the telecare system further comprises an anomaly feedback module configured to collect from the patient at least one reply to the at least one predefined question and, based on the at least one reply, determine whether the detected anomaly is a false anomaly or a true anomaly.

Preferably, the anomaly feedback module is further configured to provide information on the detected anomaly to the question generation module, if the detected anomaly is a false anomaly.

Preferably, the question generation module is configured to exclude the at least one predefined question from a further questionnaire to be submitted to the patient, if the detected anomaly is a false anomaly.

Optionally, the telecare system further comprises an alarm generation module configured to generate an alarm for the detected anomaly, if the detected anomaly is a true anomaly.

According to a third aspect, the present invention provides a computer program product, loadable in the memory of at least one computer and including software code portions for performing the steps of the method as set forth above, when the product is run on the at least one computer.

### BRIEF DESCRIPTION OF THE DRAWINGS

The present invention will become clearer from the following detailed description, given by way of example and not of limitation, to be read with reference to the accompanying drawings, wherein:

FIG. 1 schematically shows a telecare system according to an embodiment of the present invention;

FIG. 2 is a schematic flow chart of the operation of the telecare system of FIG. 1;

FIGS. 3a-3d shows four different data structures used by the telecare system of FIG. 1;

FIG. 4 is a flow chart of the operation of a first module of the telecare system of FIG. 1; and

FIG. 5 is a flow chart of the operation of a second module of the telecare system of FIG. 1.

### DETAILED DESCRIPTION OF PREFERRED EMBODIMENTS OF THE INVENTION

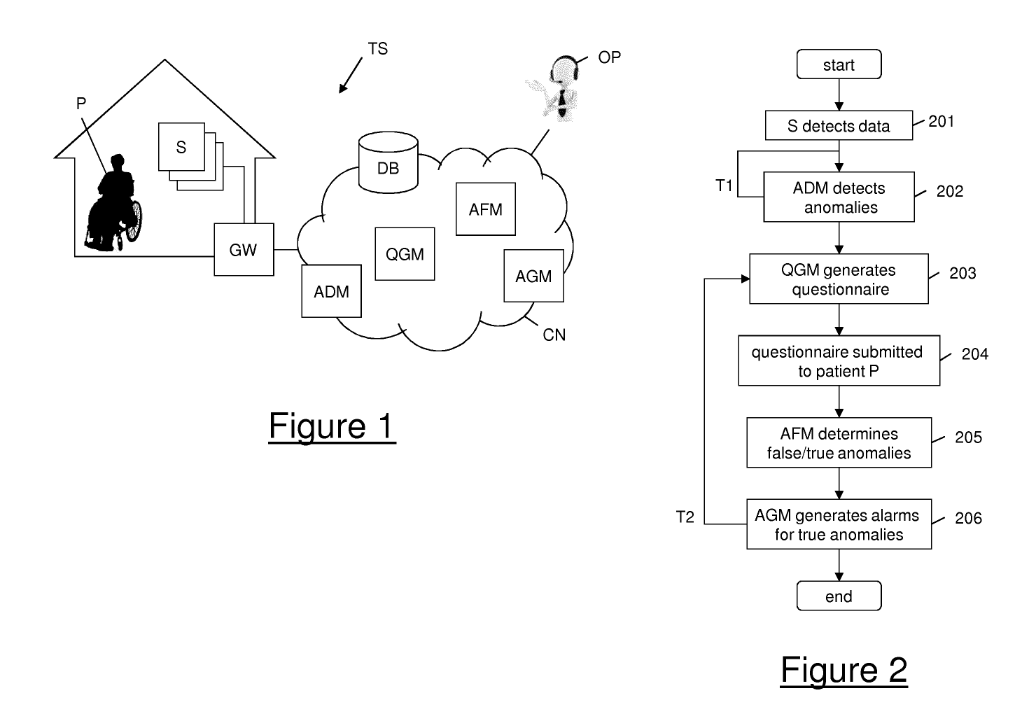

FIG. 1 schematically shows a telecare system TS suitable for providing a telecare service to a patient P, such as for instance an elderly person or a person affected by a chronic disease or a physical disability.

The telecare system TS preferably comprises one or more sensors S installed at the premises of the patient P, for monitoring the domestic environment and/or the interactions between the patient P and the domestic environment. The sensors S may comprise for instance environment parameter sensors (temperature sensors, humidity sensors, light sensors, etc.), openings control sensors (e.g. sensors for monitoring opening and closing of doors and/or windows), occupancy or passage sensors (e.g. infrared sensors or pressure sensors installed in chairs or beds), smart appliances capable of providing information about their use, electricity/gas/water meters capable of providing information about electricity/gas/water consumption, etc. The one or more sensors may be for instance compliant to the known ZigBee Home Automation Standard, which define a certain number of sensor types and the respective detected data.

The telecare system TS further preferably comprises a gateway GW, which is also installed at the premises of the patient P. The gateway GW is preferably connected to the one or more sensors S via wired or, more preferably, wireless connections. The gateway GW is preferably configured to collect data detected by the one or more sensors S.

The telecare system TS also preferably comprises a communication network CN. The communication network CN preferably comprises a data network (e.g. an IP network) and, optionally, a telephone network.

The telecare system TS also preferably comprises a database DB suitable for storing data detected by the one or more sensors S and other information, as it will be described in detail herein after.

The telecare system TS also preferably comprises a number of modules suitable for accessing the database DB and processing the information stored therein. In particular, the telecare system TS preferably comprises an anomaly detection module ADM, a questionnaire generation module QGM, an anomaly feedback module AFM and an alarm generation module AGM. The modules ADM, QGM, AFM and AGM are preferably software modules. According to a preferred variant, the modules ADM, QGM, AFM and AGM are executed in a distributed way within the communication network CN according to a cloud computing technique. According to an alternative variant (not shown in the drawings), the modules ADM, QGM, AFM and AGM are executed in a centralized way by a single computer (e.g. a server of the telecare service provider) cooperating with the gateway GW through the communication network CN. At least one of the modules ADM, QGM, AFM and AGM may be implemented by the gateway GW.

With reference now to the flow chart of FIG. 2, the operation of the telecare system TS will be described in detail.

The one or more sensors S preferably detect data relating to the domestic environment of the patient P and her/his interaction with the domestic environment (step 201).

While the one or more sensors S detect data, the anomaly detection module ADM preferably periodically detects possible anomalies in the domestic environment conditions (e.g. temperature, pressure, light, etc.) and/or in the interactions between the patient P and the domestic environment, based on the data detected by the sensors S (step 202).

In the present description and in the claims, the term “anomaly” will indicate a discrepancy between:
normal domestic environment conditions or normal daily interactions between patient P and domestic environment; and
actual domestic environment conditions or actual interactions between patient P and domestic environment as detected by the one or more sensors S.

An anomaly may be for instance a door left open for a too long time, an appliance left unused for a too long time, a too low room temperature, etc. An anomaly may be of two different types:
a predefined anomaly, namely an anomaly which may be detected by checking whether the data detected by the one or more of the sensors S fulfil a predefined condition; or
a not-predefined anomaly, namely an anomaly which may be detected by reconstructing a patients normal behaviour model based upon data detected by the sensors S and by comparing the currently detected data with such model.

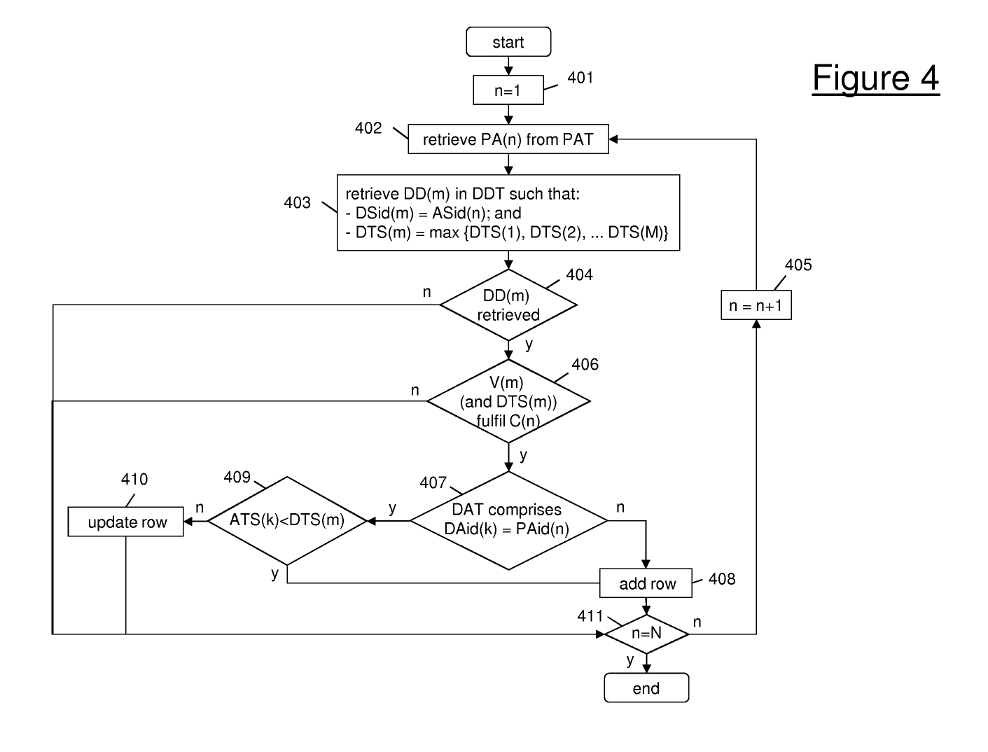

In the following description, for simplicity, reference will be made only to predefined anomalies. Hence, at step 202, the anomaly detection module ADM basically periodically checks whether each predefined anomaly is occurring or not. Step 202 is preferably periodically performed with a first period T1 (also termed herein after “anomaly detection period”), whose value is selected according to criteria which will be described in detail herein after. Step 202 will be described in further detail herein after with reference to the flow chart of FIG. 4.

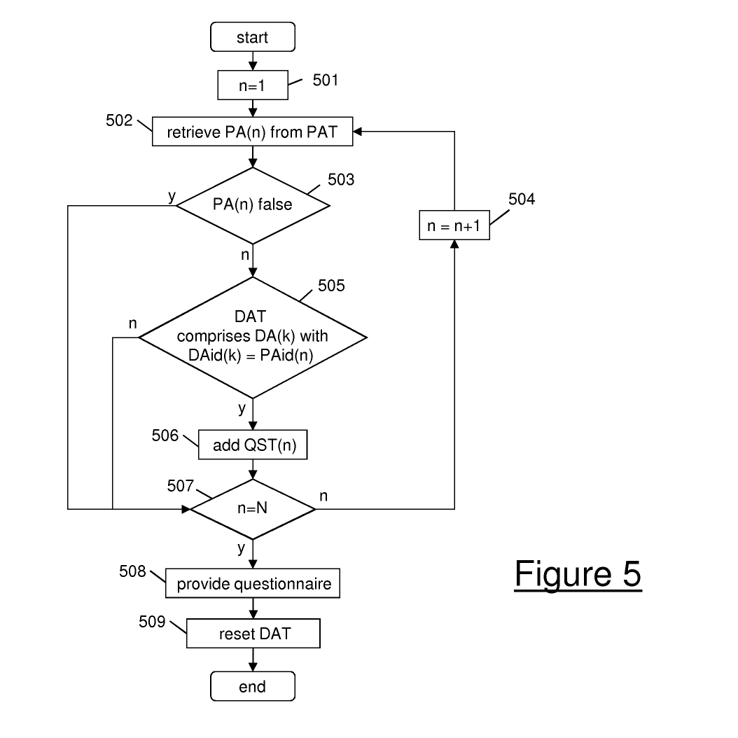

While the one or more sensors S detect data and the anomaly detection module ADM periodically detects possible anomalies, the questionnaire generation module QGM preferably periodically generates a questionnaire comprising one or more questions (step 203), based on the anomalies detected at step 202. Step 203 will be described herein after in further detail with reference to the flow chart of FIG. 5.

The questionnaire generated at each iteration of step 203 is then submitted to the patient P and her/his replies are collected (step 204). Step 204 may be carried our in various ways. According to a preferred embodiment, the questionnaire is provided to an operator OP (shown in FIG. 1) of the telecare service provider, who calls the patient P, asks her/him the questions comprised in the questionnaire and collects the replies during the call. According to other embodiments (not shown in the drawings), the questionnaire may be automatically submitted to the patient P e.g. via web or email. In that case, the questionnaire may be an electronic form which the patient P shall display on her/his PC, fill and send back to the telecare service provider. Alternatively, the questionnaire may be presented to the patient P by means of a touch screen, which the patient P may use for entering her/his replies.

Then, the anomaly feedback module AFM preferably determines, based on the patients replies, whether each one of the anomalies detected by the anomaly detection module ADM is a false anomaly (i.e. it is not due to health reasons) or a true anomaly (i.e. it is due to health reasons) (step 205). At step 205, the anomaly feedback module AFM preferably forwards information on the false anomalies to the questionnaire generation module QGM which, at the next iteration of step 203, will exclude such false anomalies from the list of detected anomalies which it uses for selecting the questions to be posed to the patient P. Further, the anomaly feedback module AFM preferably forwards information on the true anomalies to the alarm generation module AGM.

Then, the alarm generation module AGM preferably generates a corresponding alarm for each true anomaly determined at step 205 (step 206). This way, the telecare service provider may take appropriate actions, such as informing the relatives of the patient P or sending an operator to the patient's premises for further examining the patients health condition.

Steps 203-206 are preferably periodically performed with a second period (also termed herein after “patient questioning period”) T2, which is typically much longer than the anomaly detection period T1. The patient questioning period T2 may be e.g. one week.

The operation of the telecare system TS (and, in particular, of the anomaly detection module ADM and the questionnaire generation module QGM) will be now described in further detail.

As mentioned above, at step 201 the one or more sensors S installed at the patient's premises detect data relating to the domestic environment of the patient P and her/his interaction with the domestic environment. In particular, each sensor S is preferably configured to monitor the value of a certain environment parameter (e.g. room temperature, opening of a door, etc.) and to send the value of that monitored environment parameter to the gateway GW when a change of value (e.g. room temperature decreases/increases, a closed/open door is opened/closed, etc.) is detected.

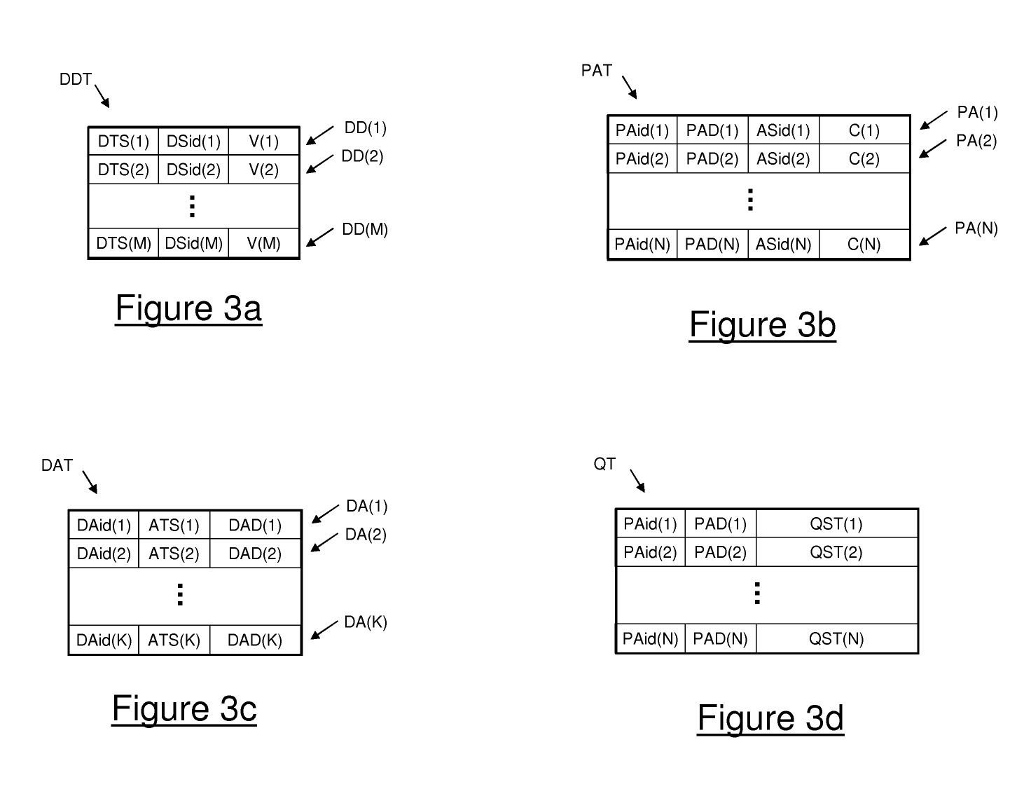

Each time one of the sensors S detects a change of value of its monitored environment parameter at step 201, it generates a corresponding detected datum DD(m) (m=1, 2, . . . M) and sends it to the gateway GW, which in turn preferably processes it. In particular, as the gateway GW receives a detected datum DD(m) from any of the sensors S, it preferably enters the detected datum DD(m) into a detected data table DDT, which it makes accessible to the anomaly detection module ADM via the communication network CN. The detected data table DDT is schematically depicted in FIG. 3a. The detected data table DDT preferably comprises a row for each detected datum DD(m). Each row preferably comprises:
a datum detection timestamp DTS(m), which indicates the date and time at which the datum DD(m) was detected (e.g. “2012-02-15 15:27:32”);
a detecting sensor identifier DSid(m) which uniquely identifies the sensor which detected the datum DD(m) amongst the one or more sensors S. The sensor identifier Sid(m) also preferably comprises the sensor location (e.g. “door sensor”); and
a value V(m) of the detected datum DD(m) (e.g. “OPEN”), namely the value of the monitored environment parameter following the detected value change.

As mentioned above, at step 202 the anomaly detection module ADM periodically detects possible anomalies in the domestic environment conditions and/or the daily interactions between the patient P and the domestic environment, based on the data detected by the sensors S. As also mentioned above, while generally speaking anomalies may be either predefined or not predefined, in the following description, for simplicity, reference will be made only to predefined anomalies.

In particular, the database DB preferably stores a number N of predefined anomalies PA(n) (n=1, 2, . . . N). The N predefined anomalies PA(1), PA(2), . . . PA(N) are preferably stored at the database DB in the form of a predefined anomaly table PAT, which is schematically shown in FIG. 3b. The predefined anomaly table PAT preferably comprises a row for each predefined anomaly PA(n). Each row preferably comprises:
a predefined anomaly identifier PAid(n), which uniquely identifies the predefined anomaly. The identifiers PAid(1), PAid(2), . . . PAid(N) may be increasing integers 1, 2, . . . N;
a predefined anomaly description PAD(n), which comprises a short description of the predefined anomaly (e.g. “door open” or “cold environment”);
an anomaly sensor identifier ASid(n) identifying the sensor which provides the data that shall be processed for determining whether the predefined anomaly PA(n) is occurring; and
a predefined condition C(n) that shall be checked upon the data detected by the sensor ASid(n) for determining whether the predefined anomaly PA(n) is occurring. If a datum detected by the sensor ASid(n) fulfils the condition C(n), the predefined anomaly PA(n) is occurring, as it will be discussed in further detail herein after with reference to the flow chart of FIG. 4.

Firstly, the anomaly detection module ADM preferably sets the index n of the predefined anomalies PA(n) to an initial value, e.g. 1 (sub-step 401)

The anomaly detection module ADM then preferably retrieves from the predefined anomaly table PAT the row corresponding to the predefined anomaly PA(n) (sub-step 402).

Then, the anomaly detection module ADM preferably looks up the detected data table DDT shown in FIG. 3a and, amongst the detected data DD(1), DD(2), . . . DD(M) currently stored therein, retrieves the most recent datum DD(m) detected by the sensor which provides the data that shall be processed for determining whether the predefined anomaly PA(n) is occurring (sub-step 403). More particularly, the module ADM retrieves from the table DDT the detected datum DD(m) which fulfils the following conditions:
(i) the detecting sensor identifier DSid(m) of the sensor which detected the datum DD(m) matches with the anomaly sensor identifier ASid(n) of the sensor which provides the data that shall be processed for determining whether the predefined anomaly PA(n) is occurring; and
(ii) the detected datum DD(m) is the most recent amongst all the detected data DD(1), DD(2), . . . DD(M) currently stored in the detected data table DDT, namely its datum detection timestamp DTS(m) has the maximum value amongst the timestamps DTS(1), DTS(2), . . . DTS(M).

For instance, if the anomaly sensor identifier ASid(n) of the predefined anomaly PA(n) retrieved at sub-step 402 from the predefined anomaly table PAT is “door sensor”, at sub-step 403 the anomaly detection module ADM retrieves from the detected data table DDT the most recent datum DD(m) detected by the door sensor.

Sub-step 403 is successful if a detected datum DD(m) is actually retrieved from the table DDT. However, in some cases, no detected datum may be retrieved from the table DDT, for instance when none of the data DD(1), DD(2), . . . DD(M) currently stored in the table DDT was detected by the sensor which provides the data that shall be processed for determining whether the predefined anomaly PA(n) is occurring. For this reason, the module ADM preferably checks whether a detected datum DD(m) was actually retrieved from the table DDT (sub-step 404).

In the negative, the module ADM concludes that none of the data DD(1), DD(2), . . . DD(M) currently stored in the table DDT is suitable for checking whether the predefined anomaly PA(n) is occurring and, accordingly, it preferably checks whether the anomaly index n equals N, which is the overall number of predefined anomalies PA(1), PA(2), . . . PA(N) stored in the predefined anomaly table PAT (sub-step 411).

In the affirmative, the module ADM concludes that all the predefined anomalies PA(1), PA(2), . . . PA(N) stored in the predefined anomaly table PAT have been checked, and accordingly the algorithm ends. Otherwise, the module ADM increases the index n by one (sub-step 405). The module ADM then returns to sub-step 402, thereby retrieving from the table PAT the next predefined anomaly.

If, at sub-step 404, the module ADM determines that a detected datum DD(m) was actually retrieved from the table DDT, the anomaly detection module ADM preferably checks whether the value V(m) (and, possibly, also the datum detection timestamp DTS(m)) of the retrieved datum DD(m) fulfil the condition C(n) of the currently considered predefined anomaly PA(n) (sub-step 406).

In particular, each condition C(1), C(2), . . . C(N) stored in the predefined anomaly table PAT may be of any of two condition types:
(a) the value V(m) is higher than, lower than or equal to a predefined value Vth (for instance, the detected room temperature is lower than Vth=5° C.); or
(b) the value V(m) equals the predefined value Vth for a time longer than, shorter than or equal to a predefined duration ΔTth (for instance, the value detected by the door sensor has been OPEN for a time longer than ΔTth=900 seconds).

If the condition C(n) of the currently considered predefined anomaly PA(n) is of type (a), at sub-step 406 the module ADM merely checks whether the value V(m) of the datum DD(m) retrieved at sub-step 403 is higher than, lower than or equal to the predefined value Vth.

Otherwise, if the condition C(n) of the currently considered predefined anomaly PA(n) is of type (b), at sub-step 406 the module ADM firstly checks whether the value V(m) of the datum DD(m) retrieved at sub-step 403 equals the predefined value Vth; then, in the affirmative, the module ADM reads the current time, calculates a difference between the current time and the datum detection timestamp DTS(m) of the datum DD(m) retrieved at sub-step 403 and finally determines whether this difference is longer than, shorter than or equal to the predefined duration ΔTth.

If the value V(m) and, possibly, the datum detection timestamp DTS(m) do not fulfil the condition C(n), the module ADM concludes that the predefined anomaly PA(n) is not occurring. The module ADM then preferably performs sub-step 411, namely it checks whether the anomaly index n equals N and, in the affirmative, the algorithm ends while, in the negative, it returns to sub-step 405 (increase the index n and consider the next predefined anomaly).

Otherwise, if the condition C(n) is met, the module ADM concludes that the predefined anomaly PA(n) is occurring. The anomaly detection module ADM then preferably writes information relating to the detected predefined anomaly in a detected anomaly table DAT also stored at the database DB (sub-steps 407, 408, 409 and 410).

As shown in FIG. 3c, the detected anomaly table DAT preferably comprises one row for each detected anomaly DA(k) (k=1, 2, . . . K), namely for each predefined anomaly PA(n) which was detected at least once. Each row preferably comprises:
a detected anomaly identifier DAid(k), which identifies the detected anomaly and which is substantially equal to the identifier of the predefined anomaly PAid(n) stored in the predefined anomaly table PAT;
an anomaly detection timestamp ATS(k), which indicates the date and time at which the anomaly DA(k) was detected (namely, the date and time at which sub-step 406 was performed with a positive outcome); and
a detected anomaly description DAD(k), which comprises a short description of the detected anomaly DA(k). The detected anomaly description DAD(k) is preferably similar to the predefined anomaly description PAD(n) of the predefined anomaly PA(n) stored in the predefined anomaly table PAT, and may be enhanced with further details derived from the detected datum DD(m) (e.g. “door open for 20 minutes”).

By referring again to the flow chart of FIG. 4, after detection of the predefined anomaly PA(n) at sub-step 406, the module ADM preferably checks whether the detected anomaly table DAT already comprises a detected anomaly DA(k) whose detected anomaly identifier DAid(k) matches the predefined anomaly identifier PAid(n) (sub-step 407).

In the negative, the module ADM concludes that the predefined anomaly PA(n) is detected for the first time (namely, its condition C(n) is met for the first time). The module ADM accordingly adds a corresponding new row in the detected anomaly table DAT (sub-step 408), the new row comprising the detected anomaly identifier DAid(k), the anomaly detection timestamp ATS(k) and the detected anomaly description DAD(k).

If, at sub-step 407, the anomaly detection module ADM determines that the detected anomaly table DAT already comprises a detected anomaly DA(k) whose detected anomaly identifier DAid(k) matches the predefined anomaly identifier PAid(n), the module ADM preferably checks whether the anomaly detection timestamp ATS(k) of such detected anomaly DA(k) stored in the table DAT is lower than the detection timestamp DTS(m) of the detected datum DD(m) fulfilling the predefined condition C(n) checked at sub-step 406 (sub-step 409). In the affirmative, the module ADM concludes that the detected anomaly DA(k) precedes the detection of the datum DD(m), and that accordingly the detected datum DD(m) fulfilling the predefined condition C(n) at the current iteration of the algorithm of FIG. 4 is indicative of a new detected anomaly of the same type as DA(k). The module ADM accordingly adds a corresponding new row DA(k′) in the detected anomaly table DAT (sub-step 408), the new row DA(k′) comprising the detected anomaly identifier DAid(k′), the anomaly detection timestamp ATS(k′) and the detected anomaly description DAD(k′). It shall be noticed that, since the detected anomaly DA(k′) is of the same type as the previously detected anomaly DA(k), the identifier DAid(k′) is equal to the identifier DAid(k), both of them being equal to the predefined anomaly identifier PAid(n).

Otherwise, if at sub-step 409 the module ADM determines that the anomaly detection timestamp ATS(k) of the detected anomaly DA(k) stored in the table DAT is not lower than the detection timestamp DTS(m), the module ADM concludes that the detected anomaly DA(k) follows the detection of the datum DD(m), and that accordingly the detected datum DD(m) fulfilling the predefined condition C(n) at the current iteration of the algorithm of FIG. 4 is indicative of a persistence of the detected anomaly DA(k). The module ADM then preferably updates the corresponding row in the table DAT (sub-step 410). In particular, the module ADM preferably replaces the anomaly detection timestamp ATS(k) with the date and time at which sub-step 406 was performed with a positive outcome for the last time. At sub-step 410, the module ADM may also update the detected anomaly description DAD(k).

For instance, the predefined anomaly PAD(n)=“door open” may be detected for the first time at a first iteration of the algorithm of FIG. 4 (in particular, of sub-step 406) at date and time “2012-02-15 16:00:00”. Assuming that the retrieved datum DD(m) upon which the check of sub-step 406 has been carried out has a datum detection timestamp DTS(m)=“2012-02-15 15:27:32”, at sub-step 408 the anomaly detection module ADM preferably adds a new row in the table DAT, comprising:
a anomaly detection timestamp ATS(k)=“2012-02-15 16:00:00” and
a detected anomaly description DAD(k)=“door open for 32 minutes”, 32 minutes being the time elapsed between the time at which sub-step 406 was carried out and the time at which the datum DD(m) was detected (for conciseness, seconds are not considered in the detected anomaly description DAD(k)).

Then, the algorithm of FIG. 4 (in particular, sub-step 406) is iterated for a second time, the second iteration of sub-step 406 occurring e.g. ten minutes later, namely at date and time “2012-02-15 16:10:00”. Assuming that in the meanwhile the door was left open, and that accordingly no further data were detected by the door sensor, at the second iteration of sub-step 403 the same retrieved datum DD(m) having datum detection timestamp DTS(m)=“2012-02-15 15:27:32” is retrieved again. The predefined anomaly PAD(n)=“door open” is then detected again on the basis of the same detected datum DD(m). The module ADM looks up the table DAT and finds that it already comprises a row relating to this anomaly. The module ADM then determines that the anomaly detection timestamp ATS(k)=“2012-02-15 16:00:00” is subsequent to the datum detection timestamp DTS(m)=“2012-02-15 15:27:32”, and that accordingly the already detected anomaly DA(k) is still persisting. The module ADM accordingly updates the corresponding row DA(k) in the table DAT by changing the values of the anomaly detection timestamp ATS(k) and the detected anomaly description DAD(k) of such row as follows:
ATS(k)=“2012-02-15 16:10:00” and
DAD(k)=“door open for 42 minutes”, 42 minutes being the time elapsed between the time at which the second iteration of sub-step 406 was carried out and the time at which the datum DD(m) was detected.

It is now assumed that the door is closed, reopened and then left open, the reopening triggering the entering into the table DDT of a further detected datum DD(m′) having e.g. datum detection timestamp DTS(m′)=“2012-02-15 16:55:00”. At the next iterations of sub-step 403, the further detected datum DD(m′) is then retrieved, its detection timestamp DTS(m′) being the most recent amongst the timestamps of data detected by the door sensor. In particular, at the first iteration of the algorithm of FIG. 4 delayed relative to the datum detection timestamp DTS(m′) by at least 20 minutes (namely, the threshold time specified in the predefined condition C(n)), the predefined anomaly PAD(n)=“door open” is then detected again on the basis of the further detected datum DD(m′). The module ADM looks up the table DAT and finds that it already comprises a row relating to this anomaly. The module ADM however determines that its anomaly detection timestamp ATS(k)=“2012-02-15 16:10:00” precedes the datum detection timestamp DTS(m′)=“2012-02-15 16:55:00”, and that accordingly a new anomaly “door open” is being detected. Assuming that the new anomaly “door open” is detected e.g. at date and time “2012-02-15 17:20:00”, the anomaly detection module ADM then preferably adds a new row DA(k′) in the table DAT, comprising:
a anomaly detection timestamp ATS(k′)=“2012-02-15 17:20:00” and
a detected anomaly description DAD(k′)=“door open for 25 minutes”, 25 minutes being the time elapsed between the time at which sub-step 406 was carried out and the time at which the further datum DD(m′) was detected.

After adding the row corresponding to the detected anomaly DA(k) or updating it in the table DAT, the module ADM preferably performs sub-step 411 (namely, it checks whether the anomaly index n equals N) and, in the affirmative, the algorithm ends while, in the negative, it returns to sub-step 405 (increase the index n and consider the next predefined anomaly).

Steps 402-411 are therefore cyclically repeated for each predefined anomaly PA(1), PA(2), . . . PA(N), until the index n equals N.

The module ADM preferably periodically iterates the whole algorithm of FIG. 4 at the above mentioned anomaly detection period T1. At each iteration of the whole algorithm, all the predefined anomalies PA(1), PA(2), . . . PA(N) stored in the predefined anomaly table PAT are checked. The anomaly detection period T1 of the algorithm of FIG. 4 is preferably shorter than the minimum amongst all the predefined durations ΔTth which might be comprised in the conditions C(1), C(2), . . . C(N) of the predefined anomalies PA(1), PA(2), . . . PA(N). For instance, by referring to the above mentioned anomaly “door open”, if the associated condition C(n) is “V(m)=OPEN for a time longer than ΔTth=900 seconds”, in order to detect this anomaly the anomaly detection period T1 of the algorithm of FIG. 4 is preferably shorter than ΔTth=900 seconds. If the anomaly detection period were longer than ΔTth=900 seconds (e.g. 1500 seconds), the algorithm would no be able to detect an anomalous situation in which the door is actually left open for a time longer than ΔTth=900 seconds and comprised between two consecutive iterations of the algorithm.

The anomaly detection module ADM may also detect not-predefined anomalies, namely anomalies not listed in the predefined anomaly table PAT. The determination of such anomalies will however not be described in further detail, since it is not relevant to the present description.

As mentioned above with reference to the flow chart of FIG. 2, the questionnaire generation module QGM periodically (e.g. once a week) generates a questionnaire comprising one or more questions (step 203) at the above mentioned patient questioning period T2, based on the anomalies detected at step 202. Step 203 will be now described in detail with reference to the flow chart of FIG. 5.

Firstly, the questionnaire generation module QGM preferably sets the index n of the predefined anomalies PA(n) to an initial value, e.g. 1 (sub-step 501).

The questionnaire generation module QGM then preferably retrieves from the predefined anomaly table PAT the row corresponding to the predefined anomaly PA(n) (sub-step 502).

The questionnaire generation module QGM then preferably checks whether the predefined anomaly PA(n) is a false anomaly or a true anomaly (sub-step 503). To this purpose, the module QGM checks whether the predefined anomaly PA(n) is comprised in a list of false anomalies provided by the anomaly feedback module AFM, as it will be described in detail herein after.

If the predefined anomaly PA(n) is comprised within the list of false anomalies, the questionnaire generation module QGM preferably ignores such predefined anomaly PA(n) and checks whether the anomaly index n equals N, which is the overall number of predefined anomalies PA(1), PA(2), . . . PA(N) stored in the predefined anomaly table PAT (sub-step 507). In the affirmative, the module QGM concludes that all the predefined anomalies PA(1), PA(2), . . . PA(N) stored in the predefined anomaly table PAT have been considered, and accordingly provides at its output a questionnaire comprising all the questions QST(n) selected at the various iterations of sub-step 506 (sub-step 508). Otherwise, the module QGM increases the anomaly index n by one (sub-step 504) and returns to sub-step 502, thereby considering the next predefined anomaly.

Otherwise, if the predefined anomaly PA(n) is not comprised within the list of false anomalies, the questionnaire generation module QGM preferably checks whether the predefined anomaly PA(n) was detected at least once by the anomaly detection module ADM (sub-step 505). To this purpose, the module QGM preferably checks whether the detected anomaly table DAT comprises at least one detected anomaly DA(k) whose detected anomaly identifier DAid(k) matches the predefined anomaly identifier PAid(n) of the predefined anomaly PA(n) retrieved at sub-step 502.

In the negative, the module QGM concludes that the currently considered predefined anomaly PA(n) was never detected by the module ADM and returns to the above described sub-step 507 thereby considering the next predefined anomaly, if any.

In the affirmative, the questionnaire generation module QGM preferably enters in the questionnaire one or more questions QST(n) for each detected anomaly DA(k) whose detected anomaly identifier DAid(k) matches the predefined anomaly identifier PAid(n) of the predefined anomaly PA(n) (sub-step 506).

More particularly, with reference to FIG. 3d, the database DB also preferably stores a question table QT. The question table QT preferably comprises a number N of rows equal to the number of predefined anomalies PA(1), PA(2), . . . PA(N). Each row of the question table preferably comprises:
the predefined anomaly identifier PAid(n) which uniquely identifies the predefined anomaly PA(n) also in the predefined anomaly table PAT;
the predefined anomaly description PAD(n) which is also included in the predefined anomaly table PAT; and
a set of questions QST(n) associated to the predefined anomaly PA(n), which comprises one or more questions aimed at checking whether the predefined anomaly PA(n) is a false anomaly or a true anomaly.

In particular, the question(s) QST(n) are preferably aimed at checking whether some extraordinary but non-critical situation occurred in the patient everyday routine which might have lead to the detected anomalous domestic environment condition or interaction between patient P and domestic environment. For instance, for the predefined anomaly PAD(n)=“door open”, the set of questions QST(n) may comprise one or more of the following questions: “Did you clean your doormat in the past few days?” or “Did you chat with some acquaintance in your doorway in the past few days?” and so on.

The question(s) QST(n) are preferably yes-no questions, so that the patient's replies may be automatically recorded and processed.

Each question QST(n) may also comprise a variable portion which the module QGM may fill using information on the detected anomaly DA(k) derived from the detected anomaly table DAT, at the purpose of making the question more specific. For instance, with reference to the above exemplary questions associated to the predefined anomaly PAD(n)=“door open”, instead of the expression “in the past few days”, the questions may comprise the date derived from the anomaly detection timestamp ATS(k). Then, if the table DAT comprises two different detected anomalies DA(k) and DA(k′) of the type “door open” detected at different dates and/or times, the question generation module QGM preferably inserts in the questionnaire two separate questions, each one comprising the date and time as derived from the respective anomaly detection timestamps ATS(k) and ATS(k′).

By referring again to the flow chart of FIG. 5, for selecting the one or more questions QST(n) associated to the detected predefined anomaly PA(n) at sub-step 506, the module QGM preferably uses the question table QT, namely it enters in the questionnaire the set of questions QST(n) which in the question table QT is associated to the predefined anomaly identifier PAid(n) of the predefined anomaly PA(n).

The questionnaire generation module QGM then preferably returns to sub-step 507, namely it checks whether the anomaly index n equals N. In the affirmative, the module QGM provides at its output a questionnaire comprising all the questions QST(n) selected at the various iterations of sub-step 506 (sub-step 508). Otherwise, the module QGM returns to sub-step 504 and considers the next predefined anomaly.

According to embodiments not shown in the drawings, the questionnaire generation module QGM may also add to the questionnaire questions for ascertaining non-predefined anomalies possibly detected by the anomaly detection module ADM. Preferably, for each non-predefined detected anomaly, the questionnaire generation module QGM may add an open predefined question of the type “Why did this anomalous domestic environment condition/anomalous interaction with the domestic environment occur?”.

Then, the module QGM preferably resets the detected anomaly table DAT (sub-step 509), which the module ADM will start filling again at its subsequent iteration of the algorithm of FIG. 4.

As mentioned above, the questionnaire provided by the module QGM is submitted to the patient P (step 204) and her/his replies are preferably collected and processed for determining false and true anomalies (step 205).

In particular, at step 205 the anomaly feedback module AFM receives the replies of the patient P and, based on them, determines whether each predefined anomaly PA(n) which was detected at least once is a false anomaly or a true anomaly. For instance, if the patient P replies “yes” to the question “Did you clean your doormat in the past few days?” associated to the anomaly “door open”, the anomaly feedback module AFM determines that the predefined anomaly “door open” is a false anomaly, namely it is not due to health reasons.

As the anomaly feedback module AFM realizes that a predefined anomaly PA(n) is a false anomaly, it preferably enters it into a list of false anomalies, which is then provided to the questionnaire generation module QGM. On the other hand, as the anomaly feedback module AFM realizes that a predefined anomaly PA(n) is a true anomaly, it preferably enters it into a list of true anomalies, which is then provided to the alarm generation module AGM.

Then, at step 206, the alarm generation module AGM generates an alarm for each anomaly included in the list of true anomalies.

The first time the algorithm of FIG. 5 is iterated after the anomaly feedback module AFM has processed the replies of the patient P, at sub-step 505 the questionnaire generation module QGM will use the list of false anomalies as updated by the anomaly feedback module AFM based on the replies of the patient P as described above. Therefore, if a predefined anomaly PA(n) has been entered into the list of false anomalies, at the next iteration of the algorithm of FIG. 5, the questionnaire generation module QGM will omit from the questionnaire any question associated to that predefined anomaly PA(n), even if that anomaly is still detected and hence entered in the table DAT. For instance, if the anomaly feedback module AFM has determined, based on the replies of the patient P, that the predefined anomaly “door open” is a false anomaly and has accordingly entered it into the list of false anomalies, at the next iteration of the algorithm of FIG. 5 the questionnaire generation module QGM will determine that the detected anomaly “door open” is comprised in the list of false anomalies, and will accordingly omit from the questionnaire any question associated to the anomaly “door open”.

According to a particularly preferred variant, the anomaly feedback module AFM may also associate an expiration time to each false anomaly, upon expiration of which the anomaly feedback module AFM removes the false anomaly from the list of false anomalies. The expiration time may be set by the anomaly feedback module AFM according to the cause of the false anomaly as derived from the replies provided by the patient P to the question(s) associated to that anomaly.

In particular, if the cause of the false anomaly is a sporadic anomalous event in the patient everyday routine (e.g., with reference to the above anomaly “door open”, the patient P actually cleaned the doormat), the expiration time is preferably set to a predefined value shorter than the patient questioning period T2. This way, the anomaly is added to the list of false anomalies but is removed therefrom before the next iteration of the algorithm of FIG. 5. Hence, next time the question generation module QGM detects at sub-step 503 that the anomaly “door open” is comprised in the detected anomaly table DAT, it adds again the associated question (e.g. “Did you clean your doormat?”) into the questionnaire for checking whether it is a false or true anomaly, since the anomaly “door open” has already been remove from the list of false anomalies.

On the other hand, if the cause of the anomaly is a lasting change of the patients everyday routine (e.g., for an anomaly “sleep for a too long time”, the patient P may have started a treatment with a sleeping drug), the expiration time is preferably set to a value equal to the duration of the change of the patients everyday routine (e.g. the duration of the treatment), which may be shorter or longer than the patient questioning period T2. This value may be derived from information provided by the patient P as she/he replies to the questionnaire. If the expiration time of the false anomaly is shorter than the patient questioning period T2, the anomaly is added to the list of false anomalies but is removed therefrom before the next iteration of the algorithm of FIG. 5. Hence, next time the question generation module QGM detects at sub-step 503 that the anomaly “sleep for a too long time” is comprised in the detected anomaly table DAT, it adds again the associated question (e.g. “Are you using a sleeping drug?”) into the questionnaire for checking whether it is a false or true anomaly, since the anomaly “sleep for a too long time” has already been removed from the list of false anomalies (the treatment being in theory already finished). On the other hand, if the expiration time of the false anomaly is longer than the patient questioning period T2, the anomaly is added to the list of false anomalies and persists therein at least until the next iteration of the algorithm of FIG. 5. Hence, next time the question generation module QGM determines at sub-step 503 that the anomaly “sleep for a too long time” is comprised in the detected anomaly table DAT, it preferably avoids adding again the associated question into the questionnaire, since the anomaly is still comprised in the list of false anomalies (the treatment being in theory still ongoing).

Hence, advantageously, according to the present invention the questions forming the questionnaire to be submitted to the patient P are selected based upon reliable, objective and constantly updated information on the patients everyday routine. The questions are indeed selected based upon anomalies in the domestic environment conditions and/or the interaction between the patient P and the domestic environment, which are automatically detected based upon data detected by the sensors S installed at the premises of the patient P. The data detected by the sensors S are advantageously objective and reliable, differently from data provided by the patients themselves or data provided by sensors that should be worn by the patient P. The data detected by the sensors moreover are always updated, since the sensors S continuously monitor the domestic environment and the interactions between patient P and domestic environment 24 hours a day. Possible anomalies are then immediately detected so that, at the next generation of a questionnaire, the inherent questions will be promptly added to the questionnaire for checking whether the anomaly is false or true.

The method is also very convenient for the patient, since she/he does not have to wear any sensor and, moreover, she/he has to answer a very reduced number of questions relating only to possible anomalies detected in her/his domestic environment and/or interaction with the domestic environment.

The method is also very convenient for the telecare service provider, since the questionnaire is generated and updated automatically, without requiring any manual intervention by the operators.

1. A method for providing a telecare service to a patient, the method comprising:
a) detecting, by at least one sensor installed in a domestic environment of the patient, a datum relating to the domestic environment or an interaction between the patient and the domestic environment;
b) detecting an anomaly in the domestic environment or in the interaction between the patient and the domestic environment based on the detected datum; and
c) selecting at least one predefined question uniquely associated with the detected anomaly for generating a questionnaire to be submitted to the patient for determining a cause of the detected anomaly.

2. The method according to claim 1, wherein the step b) comprises checking whether the detected datum fulfills a predefined condition associated with the predefined anomaly.

3. The method according to claim 2, wherein the step b) comprises checking whether a value of the detected datum is lower than, higher than or equal to a predefined value Vth.

4. The method according to claim 2, wherein the step b) comprises checking whether a value of detected datum is equal to a predefined value Vth for a time longer than, shorter than or equal to a predefined duration ΔTth.

5. The method according to claim 4, wherein the step b) is periodically performed with a predefined anomaly detection period.

6. The method according to claim 5, wherein predefined anomaly detection period is shorter than the predefined duration ΔTth.

7. The method according to claim 1, wherein the step c) comprises retrieving the at least one predefined question from a database storing an association between the anomaly and the at least one predefined question.

8. The method according to claim 1, further comprising:
d) submitting the at least one predefined question to the patient; and
e) collecting from the patient at least one reply to the at least one predefined question.

9. The method according to claim 8, wherein the steps d) and e) are automatically performed via web.

10. The method according to claim 8, further comprising:
based on the at least one reply, determining whether the detected anomaly is a false anomaly or a true anomaly.

11. The method according to claim 10, wherein the method further comprises excluding the at least one predefined question from a next questionnaire to be submitted to the patient, in case said that the step f) determined that the detected anomaly is a false anomaly.

12. The method according to claim 10, wherein the f) further comprises, if detected anomaly is a false anomaly, associating an expiration time to with the false anomaly.

13. The method according to claim 12, further comprising selecting again at least one predefined question for generating a further questionnaire to be submitted to the patient, if the expiration time has expired.

14. A telecare system for providing a telecare service to a patient, telecare system comprising:
a) at least one sensor installed in a domestic environment of the patient, the at least one sensor being suitable for detecting a datum relating to the domestic environment or an interaction between the patient and the domestic environment;
b) at least one computer; and
c) memory storing software code portions that, when executed by the computer, perform steps comprising:
detecting an anomaly in the domestic environment or in the interaction between the patient and the domestic environment based on the detected datum; and
c) selecting at least one predefined question uniquely associated with the detected anomaly for generating a questionnaire to be submitted to patient for determining a cause of the detected anomaly.

15. Non-transitory computer readable media having instructions stored thereon that, when executed by at least one computer, perform steps comprising:
detecting an anomaly in a domestic environment or in an interaction between a patient and the domestic environment based on a datum relating to the domestic environment or an interaction between the patient and the domestic environment, the datum being detected at least one sensor installed in a domestic environment of the patient; and
selecting at least one predefined question uniquely associated with the detected anomaly for generating a questionnaire to be submitted to the patient for determining a cause of the detected anomaly.
